(19) United States
(12) Patent Application Publication
(10) Pub. No.: US 2026/0241278 A1
(43) Pub. Date: Aug. 20, 2026

(54) CURB BALL GAME DEVICE

(71) Applicant: Hezekiah Moore, Canal Winchester, OH (US)

(72) Inventor: Hezekiah Moore, Canal Winchester, OH (US)

(21) Appl. No.: 19/540,899

(22) Filed: Feb. 16, 2026

Related U.S. Application Data
(60) Provisional application No. 63/760,688, filed on Feb. 20, 2025.

(51) Int. Cl. A63F 13/46; A63B 59/20; A63B 63/00; A63B 67/02; A63F 13/795

(52) U.S. Cl. CPC A63F 13/46; A63B 59/20; A63B 63/00; A63B 67/02; A63F 13/795; A63B 2225/09; A63B 2225/093

(57) ABSTRACT

The device is comprised of an amusement game for multiple players. The device comprises multiple curb-shaped scoring targets spaced apart and a ball configured for projection between opposing players. Each scoring target comprises a substantially planar bottom surface for stable placement on a horizontal surface, a front surface oriented toward an opposing player, and a top surface configured to provide predictable rebound behavior. A transition area positioned between the front surface and the top surface modifies ball trajectory upon impact and comprises one or more curved surfaces configured to produce upward rebounds, angled deflections, or returns toward a throwing player based on impact conditions. Each scoring target further comprises an anchor receiving point configured to accept stake-type fasteners, posts, or base plates. During play, players alternate projecting the ball toward an opposing scoring target, with impacts against designated surfaces producing scoring events defined by predetermined rules.

### CROSS-REFERENCE TO RELATED APPLICATION

The present application claims priority to, and the benefit of, U.S. Provisional Application No. 63/760,688, which was filed on Feb. 20, 2025, and is incorporated herein by reference in its entirety.

### FIELD OF THE INVENTION

The present invention relates generally to the field of amusement games. More specifically, the present invention relates to an amusement game for two or more players that uses opposing curb-shaped scoring targets and a ball to enable interactive, point-based gameplay in indoor or outdoor environments. Accordingly, the present disclosure makes specific reference thereto. Nonetheless, it is to be appreciated that aspects of the present invention are also equally applicable to other like applications, devices, and methods of manufacture.

### BACKGROUND

People commonly seek recreational activities that promote social interaction among friends, family members, and broader community groups. Many existing games become repetitive over time, which can reduce engagement and diminish long-term participation. Certain games are designed with limitations that restrict use to specific age groups, physical abilities, or a fixed number of participants. These restrictions can prevent inclusive participation and exclude individuals who wish to engage in shared recreational experiences. A lack of accessible games may contribute to missed opportunities for social bonding and cooperative play. In some cases, available games do not adequately support the development of coordination and motor skills across varied user groups. Individuals with visual impairments may face additional barriers due to the reliance of many games on complex visual cues or fast-paced motion. As a result, there exists a need for a game that is adaptable, inclusive, portable, and capable of sustaining interest across diverse environments and participant demographics.

Therefore, there exists a long-felt need in the art for a curb ball game device that provides an engaging and varied gameplay experience that reduces repetition and boredom. There also exists a long-felt need in the art for a curb ball game device that accommodates players of different ages, physical abilities, and skill levels in a shared activity. Moreover, there exists a long-felt need in the art for a curb ball game device that is portable, adaptable to indoor and outdoor environments, and suitable for inclusive recreational use.

The subject matter disclosed and claimed herein, in one embodiment thereof, comprises a curb ball game device. The device is comprised of an amusement game for two or more players that is configured for rapid deployment in a variety of settings. The device may comprise at least two curb-shaped scoring targets positioned at a distance from one another and at least one ball configured to be projected between opposing players. Each scoring target may comprise a substantially planar bottom surface for stable placement on a horizontal surface. The body may further comprise opposing side surfaces, a front surface oriented toward an opposing player, a top surface configured to support predictable rebound behavior, and a transition area positioned between the front surface and the top surface to modify ball trajectory upon impact. The transition area may comprise one or more curved surfaces selected to generate upward rebounds, angled deflections, or returns toward a throwing player based on impact conditions. At least one handle may be integrated into a side surface to facilitate transport and repositioning of each scoring target. Each scoring target may further comprise at least one anchor receiving point configured to accept an anchoring element selected from stake-type fasteners, posts, or base plates with suction, magnetic, or adhesive coupling features. During play, players alternate projecting the ball toward an opposing scoring target, with impacts against designated surfaces corresponding to scoring events defined by predetermined rules.

In this manner, the curb ball game device of the present invention accomplishes all the foregoing objectives and provides an inclusive and engaging recreational game that addresses limitations associated with conventional games. More specifically, the curb-shaped scoring targets, transition surfaces, and varied scoring rules promote continued interest and reduce monotony during repeated play. The configurable distances and anchoring options further allow the device to be used in various environments. The portable construction and rapid setup further support gameplay at social gatherings, outdoor events, and indoor locations. The projectile and rebound characteristics support development of coordination and motor skills while remaining accessible to users with visual impairments. Accordingly, the device provides a practical solution that enhances social interaction, inclusivity, and long-term enjoyment in recreational play.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a curb ball game device. The device is an amusement game configured for use by two or more players. The device is comprised of a throwable ball and multiple curb-shaped scoring targets positioned at a distance from one another. The device supports rapid setup and use in indoor and outdoor environments.

In one embodiment, the device is comprised of at least two curb-shaped scoring targets. Each scoring target includes a main body. Each curb-shaped scoring target includes a substantially flat bottom surface for stable placement on a horizontal substrate. The body further includes opposing side surfaces extending upward from the bottom surface, a front surface oriented toward a player, and a generally planar top surface configured to provide predictable rebound behavior. A transition area is formed between the front surface and the top surface. The transition area includes one or more curved surfaces configured to modify the trajectory of a ball upon impact, thereby producing varied rebound paths depending on impact conditions.

Each side surface may include a handle configured to facilitate transport and repositioning of the scoring target. Each side surface may further include at least one anchor receiving point configured to accept an anchoring element. The anchor receiving point includes an opening sized to receive an anchor selected based on the underlying surface and desired attachment strength.

In one embodiment, the anchor includes a stake-type fastener configured for insertion into penetrable ground surfaces. In an alternate embodiment, the anchor includes a post insertable through the anchor receiving point and secured using a stop and a secondary fastening component to resist displacement. The post may be coupled to a base plate configured for attachment to a surface. The base plate may include a suction cup, magnetic coupler, or adhesive element to secure the scoring target to smooth or rigid substrates.

During gameplay, opposing curb-shaped scoring targets are positioned at a selected distance apart, with players positioned behind respective targets. Players alternate turns projecting the ball toward an opposing target and contact with designated surfaces of the target is identified as a scoring event. Scoring rules may vary depending on game configuration. Point values may be assigned based on throwing position, shot type, or agreed-upon trick shots. Additional attempts may be granted following successful scoring events, and gameplay may conclude upon reaching a predetermined score threshold or completion of a defined number of rounds.

The invention further includes a method of using the device. The method includes providing at least two curb-shaped scoring targets and at least one ball, positioning the scoring targets on a horizontal substrate facing opposing players, and optionally anchoring the scoring targets to the substrate. Players alternate projecting the ball toward an opposing target, scoring events are observed and evaluated according to predetermined rules, points are awarded based on shot conditions, and gameplay continues until a predefined endpoint condition is satisfied.

Accordingly, the curb ball game device of the present invention is particularly advantageous as it provides an inclusive and engaging recreational game that addresses limitations associated with conventional games. More specifically, the curb-shaped scoring targets, transition surfaces, and varied scoring rules promote continued interest and reduce monotony during repeated play. The configurable distances and anchoring options further allow the device to be used in various environments. The portable construction and rapid setup further support gameplay at social gatherings, outdoor events, and indoor locations. The projectile and rebound characteristics support development of coordination and motor skills while remaining accessible to users with visual impairments. Accordingly, the device provides a practical solution that enhances social interaction, inclusivity, and long-term enjoyment in recreational play.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to the provided drawings in which similar reference characters refer to similar parts throughout the different views, and in which:

FIG. 1 illustrates a front perspective exploded view of a scoring target, a ball, and an anchoring element of one potential embodiment of a curb ball game device of the present invention in accordance with the disclosed architecture;

FIG. 2 illustrates a perspective view of an anchoring element of one potential embodiment of a curb ball game device of the present invention in accordance with the disclosed architecture;

FIG. 3 illustrates a rear perspective view of a scoring target and an anchoring element of one potential embodiment of a curb ball game device of the present invention in accordance with the disclosed architecture;

FIG. 4 illustrates a perspective view of an anchoring element of one potential embodiment of a curb ball game device of the present invention in accordance with the disclosed architecture; and

FIG. 5 illustrates a flowchart of a method of using one potential embodiment of a curb ball game device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a curb ball game device that provides an engaging and varied gameplay experience that reduces repetition and boredom. There also exists a long-felt need in the art for a curb ball game device that accommodates players of different ages, physical abilities, and skill levels in a shared activity. Moreover, there exists a long-felt need in the art for a curb ball game device that is portable, adaptable to indoor and outdoor environments, and suitable for inclusive recreational use.

The present invention, in one exemplary embodiment, is comprised of a curb ball game device. The device is an amusement game playable by two or more participants. Gameplay is achieved using a throwable ball and a plurality of curb-shaped scoring targets arranged at spaced locations. The device is adapted for quick installation and use within both indoor and outdoor environments.

In one embodiment, the device includes at least two curb-shaped scoring targets, each scoring target having a main body. Each curb-shaped scoring target includes a substantially flat bottom surface configured to rest stably on a horizontal substrate. The main body further includes opposing side surfaces extending upward from the bottom surface, a front surface oriented toward a player, and a generally planar top surface configured to produce consistent rebound behavior. A transition area is positioned between the front surface and the top surface, the transition area including one or more curved surfaces configured to alter ball trajectory upon impact and generate varied rebound paths based on impact conditions.

Each side surface may be provided with a handle configured to assist with carrying and repositioning the scoring target. Each side surface may also include at least one anchor receiving point configured to receive an anchoring element. The anchor receiving point includes an opening sized to accommodate an anchor selected according to the underlying surface and a desired level of attachment security.

In one embodiment, the anchor is provided as a stake-type fastener configured for insertion into penetrable ground surfaces. In an alternate embodiment, the anchor is provided as a post insertable through the anchor receiving point and retained using a stop in combination with a secondary fastening component to resist displacement. The post may be coupled to a base plate configured for attachment to a surface. The base plate may include a suction cup, magnetic coupler, or adhesive element configured to secure the scoring target to smooth or rigid substrates.

During gameplay, opposing curb-shaped scoring targets are arranged at a selected distance from one another, with players positioned behind respective scoring targets. Players take turns projecting the ball toward an opposing scoring target and contact between the ball and designated surfaces of the scoring target is identified as a scoring event. Scoring rules may vary depending on game configuration, with point values assigned based on throwing position, shot type, or agreed-upon trick shots. Successful scoring events may allow additional attempts, and gameplay may conclude upon attainment of a predetermined score threshold or completion of a defined number of rounds.

A method includes providing at least two curb-shaped scoring targets and at least one ball, positioning the scoring targets on a horizontal substrate with front surfaces facing opposing players, and optionally anchoring the scoring targets to the substrate. Players alternate projecting the ball toward an opposing scoring target, scoring events are observed and evaluated according to predetermined rules, points are awarded based on shot conditions, and gameplay continues until a predefined endpoint condition is achieved.

Accordingly, the device provides an inclusive and engaging recreational activity that overcomes limitations associated with conventional games. The curb-shaped scoring targets, transition surfaces, and adaptable scoring rules promote sustained player interest and reduce monotony during repeated play. Adjustable target spacing and multiple anchoring options allow use across varied environments. Portable construction and rapid setup support use during social gatherings, outdoor events, and indoor activities. The projectile characteristics and rebound behavior encourage development of coordination and motor skills while remaining accessible to users with visual impairments. As a result, the device enhances social interaction, inclusivity, and long-term enjoyment in recreational play.

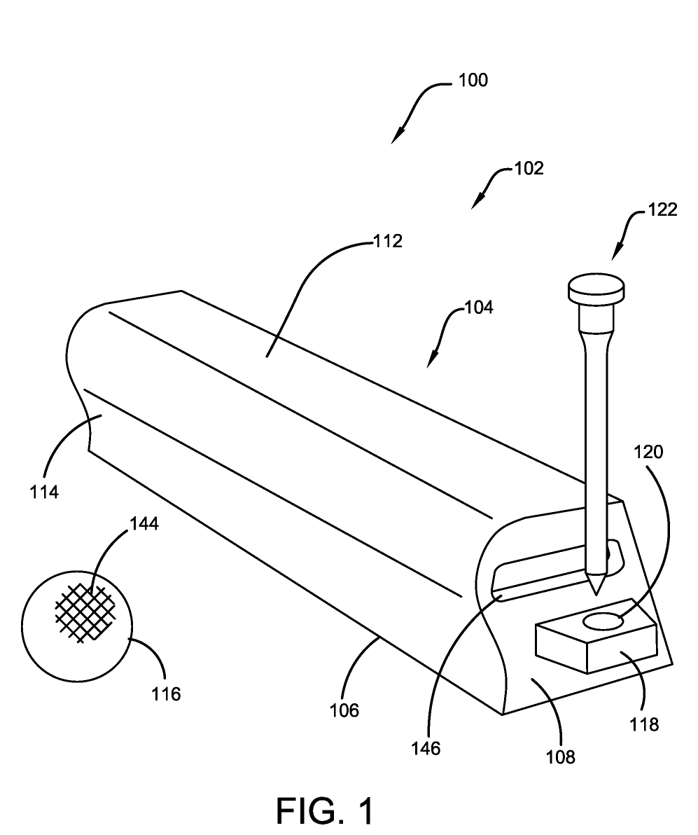

Referring initially to the drawings, FIG. 1 illustrates a front perspective exploded view of a scoring target 102, a ball 116, and an anchoring element 122 of one potential embodiment of a curb ball game device of the present invention in accordance with the disclosed architecture

The device 100 is an amusement game designed for use by two or more players. More specifically, the device 100 is comprised of a ball 116 that is thrown toward designated curb-shaped targets 102 positioned at a distance from one another. The device 100 is designed for rapid setup in diverse environments, including indoor and outdoor settings.

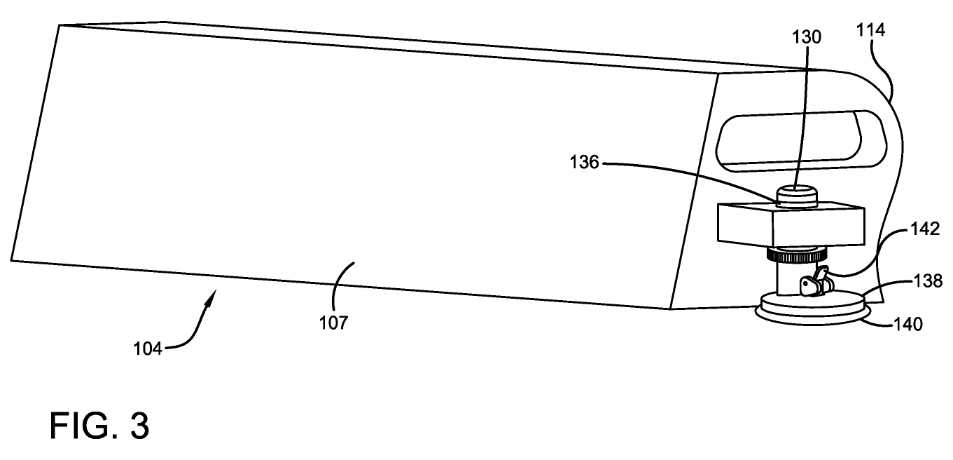

In one embodiment, the device 100 is comprised of at least two curb-shaped scoring targets 102, as seen in FIGS. 1 and 3. Each curb-shaped scoring target 102 may be comprised of a main body 104 made from materials such as but not limited to high-density polyethylene (HDPE), polypropylene, rubber composites, thermoplastic elastomers, treated wood, or metal alloys.

Each curb-shaped target 102 may comprise a bottom surface 106 that is substantially flat and planar, allowing for stable placement of the target 102 on a horizontal substrate. The body 104 may further be comprised of a rear surface 107, side surfaces 108 that are generally vertical and parallel to one another, extending perpendicularly from the bottom surface 106. A front surface 110 may be substantially vertical and either planar or non-planar depending on the embodiment. A top surface 112 is preferably flat and planar to support consistent rebound characteristics.

A transition area 114 may be formed between the front surface 110 and the top surface 112. The transition area 114 may be comprised of one or more continuously curved surfaces configured to alter the trajectory of an impacting ball 116. The curvature of the transition area 114 may be symmetrical or asymmetrical and may be selected to produce varied ball deflections including upward rebounds or redirections back toward the originating player, depending on the angle and velocity of impact.

Each side surface 108 may further be comprised of a handle 146, as seen in FIGS. 1 and 3, to facilitate manual repositioning and transport of the scoring target 102. The handle 146 may be in the form of a recessed cavity, external loop, bar, or flexible strap. Material for the handle 146 includes but are not limited to molded plastic, thermoplastic elastomers, reinforced rubber, or woven textile webbing.

Each side surface 108 may additionally comprise at least one anchor receiving point 118. The anchor receiving point 118 may be formed as an outwardly projecting boss, flange, or housing and may include a central opening 120, as seen in FIG. 1. The opening 120 may be circular, slotted, or polygonal in shape and dimensioned to accept an anchoring element 122. The anchor 122 may be selected based on the type of underlying surface and desired level of attachment security.

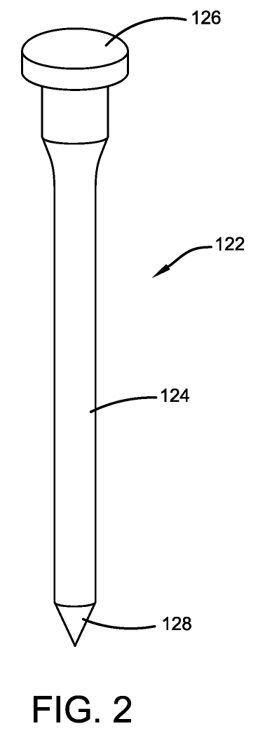

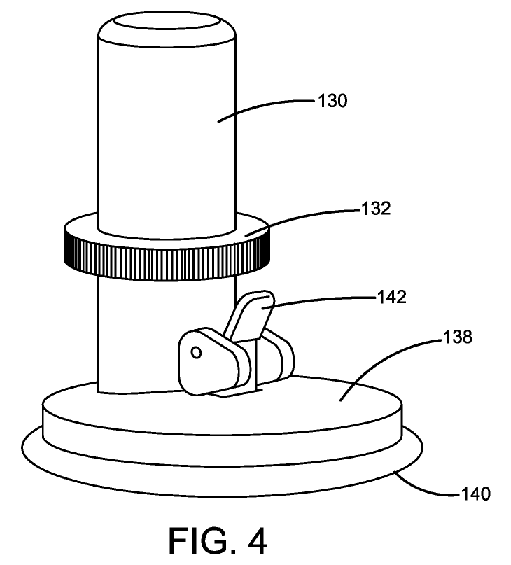

In one embodiment, the anchor 122 is comprised of a stake-type fastener with a shaft 124, a head 126 that may be flat, domed, or convex, and a pointed or tapered end 128 as seen in FIG. 2. The anchor 122 may be driven into penetrable surfaces such as grass, soil, or compacted dirt. In an alternate embodiment, the anchor 122 may be comprised of a post 130 (as seen in FIG. 4) insertable through the opening 120, as seen in FIG. 3. The post 130 may include an integral stop 132, such as but not limited to a flange, shoulder, or collar, positioned below the opening 120 to provide upward resistance. Above the stop 132, a secondary fastening component 134 may be employed, as seen in FIG. 3. The secondary fastening component 134 may be comprised of a nut, twist-lock, cotter pin, spring clip, compression clamp, or other mechanical retention feature 136 to secure the post 130 against displacement.

The post 130 may further be fixed to a base plate 138 configured for surface coupling. The base plate 138 may be comprised of an attachment fastener 140 such as but not limited to a suction cup, magnetic coupler, or adhesive pad. In an embodiment wherein the fastener 140 is a suction cup, the cup may be actuated or released by a lever mechanism 142 to engage or disengage vacuum pressure against a smooth, non-porous substrate such as tile, polished concrete, epoxy floors, or vinyl. In alternate configurations, the base plate 138 may be magnetically coupled to ferromagnetic surfaces.

The projectile used in gameplay may be a ball 116. The ball 116 is generally spherical and may be fabricated from rubber, polymer foams, thermoplastic elastomers, synthetic leathers, or other impact-absorbing compounds. The ball 116 may vary in diameter, mass, or compressibility to accommodate player skill levels or game variants. The outer surface of the ball 116 may be comprised of a texture 144 such as but not limited to ridges, dimples, knurling, or patterned embossments to enhance grip, control, or flight behavior.

During gameplay, two curb-shaped targets 102 may be positioned at a distance apart, with each player standing behind one of the targets 102. The distance between the targets 102 may be adjusted according to player age, desired difficulty level, or playing area dimensions. Players alternate turns projecting the ball 116 toward the opposing target 102. Impact with the front surface 110, transition area 114, and/or or top surface 112 may be designated as a scoring event, with corresponding point values of at least one point assigned.

Scoring rules may vary. In one embodiment, a direct hit from the full starting position may award 10 points, while a successful shot from a halfway point between the targets 102 may earn 5 points. Trick shots, including but not limited to underhand tosses, behind-the-back launches, backward throws, or banked trajectories, may carry distinct bonus point values as agreed upon prior to gameplay. Following a successful hit, the scoring player may be allowed up to three consecutive additional attempts from a halfway point, terminating either after three shots or upon a missed attempt. The game may be concluded when a player achieves a predefined score threshold, such as but not limited to 100 points, or after a fixed number of rounds.

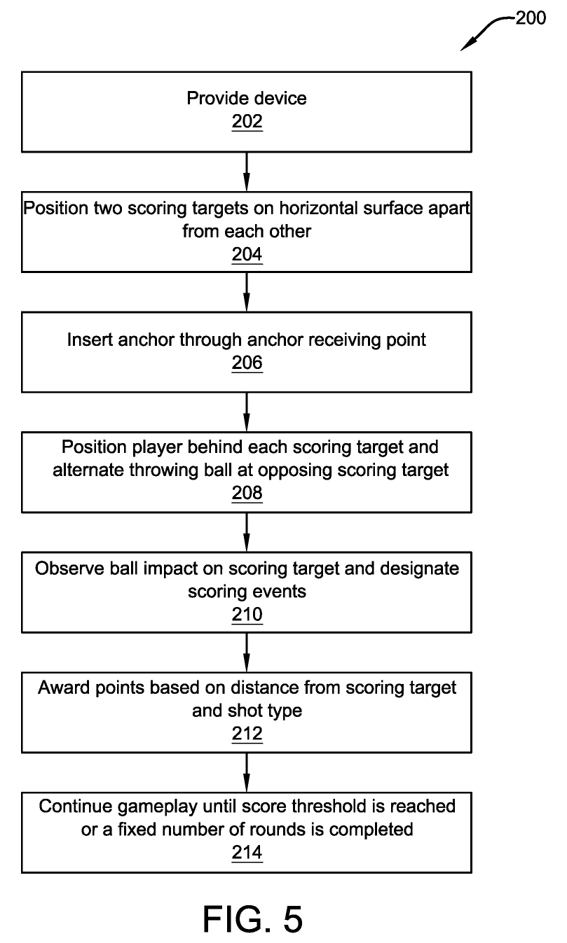

The present invention is also comprised of a method of using 200 the device 100 as seen in FIG. 5. First, a device 100 is provided comprised of at least two curb-shaped scoring targets 102 each having a body 104 with a bottom surface 106, side surfaces 108, a front surface 110, a top surface 112, and a transition area 114 and at least one ball 116 [Step 202]. Then, two curb-shaped scoring targets 102 are positioned on a horizontal surface at a distance from one another, with each target 102 oriented such that the front surface 110 of each target 102 faces an opposing player (and the opposing target 102) [Step 204]. Next, when anchoring is desired, an anchor 122 is inserted through an anchor receiving point 118 of each curb-shaped scoring target 102 and secured to the underlying surface using either a stake-type fastener driven into a penetrable surface or a post 130 coupled to a base plate 138 configured for surface attachment [Step 206]. Then, at least one player positions themselves behind each curb-shaped scoring target 102 and alternate turns projecting the ball 116 toward an opposing target 102 [Step 208]. Next, impacts of the ball 116 with the front surface 110, transition area 114, and/or top surface 112 are observed and designated as scoring events according to predetermined scoring rules [Step 210]. Then, points are awarded based on shot type and throwing position, including full-distance throws, halfway-point throws, or agreed-upon trick shots, and additional attempts are granted when applicable [Step 212]. Finally, gameplay is continued until a predefined score threshold is reached or a fixed number of rounds is completed, thereby concluding use of the device 100 [Step 214].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “curb ball game device” and “device” are interchangeable and refer to the curb ball game device 100 of the present invention.

Notwithstanding the foregoing, the curb ball game device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the curb ball game device 100 as shown in the FIGS. are for illustrative purposes only, and that many other sizes and shapes of the curb ball game device 100 are well within the scope of the present disclosure. Although the dimensions of the curb ball game device 100 are important design parameters for user convenience, the curb ball game device 100 may be of any size, shape, and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A curb ball game device comprising:
a scoring target comprising:
a body having a bottom surface, a side surface, a front surface, a top surface, and a transition area formed between the front surface and the top surface;
an anchor receiving point formed on the side surface, wherein the anchor receiving point is comprised of an opening; and
an anchor positioned through the opening.

2. The curb ball game device of claim 1, wherein the anchor is comprised of a stake.

3. The curb ball game device of claim 1, wherein the transition area is comprised of a curved surface.

4. The curb ball game device of claim 1, wherein the curve surface is symmetrical or asymmetrical.

5. The curb ball game device of claim 1, wherein the side surface is comprised of a handle.

6. The curb ball game device of claim 1 further comprising a ball.

7. The curb ball game device of claim 2, wherein the stake is comprised of a head and a pointed end or a tapered end.

8. A curb ball game device comprising:
a scoring target comprising:
a body having a bottom surface, a side surface, a front surface, a top surface, and a transition area formed between the front surface and the top surface;
an anchor receiving point formed on the side surface, wherein the anchor receiving point is comprised of an opening;
a post inserted through the opening, the post comprising an integral stop positioned on the post below the opening;
a secondary fastening component positioned above the opening to resist displacement of the post within the opening; and
a base plate fixed to the post, wherein the base plate is comprised of an attachment fastener.

9. The curb ball game device of claim 8, further comprising a ball.

10. The curb ball game device of claim 8, wherein the integral stop is a flange, a shoulder, or a collar.

11. The curb ball game device of claim 8, wherein the integral stop is comprised of a nut, a twist-lock, a cotter pin, a spring clip, or a compression clamp.

12. The curb ball game device of claim 8, wherein the attachment fastener is a suction cup, a magnetic coupler, or an adhesive pad.

13. The curb ball game device of claim 12, wherein the suction cup is comprised of an actuated by a lever mechanism.

14. The curb ball game device of claim 8, wherein the transition area is comprised of a curved surface.

15. The curb ball game device of claim 8, wherein the curve surface is symmetrical or asymmetrical.

16. The curb ball game device of claim 8, wherein the side surface is comprised of a handle.

17. A method of using a curb ball game device, the method comprising the following steps:
providing a curb ball game device comprised of a ball, a first scoring target and a second scoring target, wherein the first scoring target and the second scoring target are each comprised of a body comprised of a bottom surface, a side surface, a front surface, a top surface, a transition area, and an anchor receiving point;
positioning the first scoring target and the second scoring target on a horizontal surface, wherein the second scoring target is positioned at a distance from the first scoring target, and wherein the front surface of the first scoring target and the second scoring target oppose each other;
anchoring the first scoring target and the second scoring target to the horizontal surface;
alternating turns projecting the ball toward the first scoring target or the second scoring target;
observing an impact of the ball with the front surface, the transition area, and the top surface; and
designating the impact as a scoring event according to a predetermined scoring rule.

18. The curb ball game device of claim 17 further comprising a step of driving an anchor through an anchor receiving point on the body and into the horizontal surface.

19. The curb ball game device of claim 17 further comprising a step of inserting a post through an anchor receiving point on the body.

20. The curb ball game device of claim 19 further comprising a step of attaching the post to the horizontal surface via an attachment fastener of the post.
